(19) United States
(12) Patent Application Publication
(10) Pub. No.: US 2022/0339783 A1
(43) Pub. Date: Oct. 27, 2022

(54) FORCE DETECTION APPARATUS AND ROBOT SYSTEM

(71) Applicant: SEIKO EPSON CORPORATION, Tokyo (JP)

(72) Inventors: Hiroki KAWAI, MATSUMOTO-SHI (JP); Takayuki KIKUCHI, CHINO-SHI (JP); Michiyasu HIROTA, MATSUMOTO-SHI (JP)

(21) Appl. No.: 17/723,502

(22) Filed: Apr. 19, 2022

(30) Foreign Application Priority Data
Apr. 21, 2021 (JP) 2021-072065

(51) Int. Cl. B25J 9/16; G01L 5/00

(52) U.S. Cl. CPC B25J 9/1633; G01L 5/009

(57) ABSTRACT

A force detection apparatus includes first and second force sensors each including a force detection device having a force detection axis, a first inertial sensor disposed in the vicinity of the first force sensor and having an inertia detection axis extending along the force detection axis of the first force sensor, and a second inertial sensor disposed in the vicinity of the second force sensor and having an inertia detection axis extending along the force detection axis of the second force sensor.

The present application is based on, and claims priority from JP Application Serial Number 2021-072065, filed Apr. 21, 2021, the disclosure of which is hereby incorporated by reference herein in its entirety.

### BACKGROUND

### 1. Technical Field

The present disclosure relates to a force detection apparatus and a robot system.

### 2. Related Art

The robot described in JP-A-2018-072135 is capable of detecting an external force acting on an actuator fitted to the tip of a robot arm. When the actuator includes a fixed section fixed to the robot and a movable section movable relative to the fixed section, the robot causes an acceleration detector to detect acceleration of the fixed section, causes a position detector to detect the position of the movable section relative to the fixed section, causes a position controller to output a current command value based on the difference between the position detected by the position detector and a reference position, causes an acceleration compensator to output an acceleration compensation value based on the result of multiplication of the acceleration detected by the acceleration detector by the mass of the movable section, causes an adder/subtractor to add the acceleration compensation value to the current command value, causes a constant current control section to make the current value of a drive current equal to the current command value, and cause an external force detection section to detect the external force based on the result of subtraction of the acceleration compensation value from the current value of the drive current.

The robot described in JP-A-2018-072135, however, does not use a force sensor that physically detects the external force that the actuator receives and therefore has a problem of low detection accuracy.

### SUMMARY

A force detection apparatus according to an aspect of the present disclosure includes first and second force sensors each including a force detection device having a force detection axis, a first inertial sensor disposed in a vicinity of the first force sensor and having an inertia detection axis extending along the force detection axis of the first force sensor, and a second inertial sensor disposed in a vicinity of the second force sensor and having an inertia detection axis extending along the force detection axis of the second force sensor.

A robot system according to another aspect of the present disclosure includes a robot, a force detection apparatus incorporated in the robot, and a robot control apparatus that controls the operation of driving the robot based on a result of detection performed by the force detection apparatus, and the force detection apparatus includes first and second force sensors each including a force detection device having a force detection axis, a first inertial sensor disposed in a vicinity of the first force sensor and having an inertia detection axis extending along the force detection axis of the first force sensor, and a second inertial sensor disposed in a vicinity of the second force sensor and having an inertia detection axis extending along the force detection axis of the second force sensor.

### BRIEF DESCRIPTION OF THE DRAWINGS

FIG. 1 is an overall configuration diagram of a robot system according to a preferable embodiment.

FIG. 2 is a perspective view showing a force detection apparatus.

FIG. 3 is a longitudinal cross-sectional view showing the force detection apparatus.

FIG. 4 is a lateral cross-sectional view showing the force detection apparatus.

FIG. 5 is a longitudinal cross-sectional view showing each force sensor.

FIG. 6 is a longitudinal cross-sectional view showing a force detection device.

FIG. 7 is a schematic diagram showing the arrangement of the force sensors and inertial sensors.

FIG. 8 is an exploded perspective view showing each of the inertial sensors.

FIG. 9 is a perspective view showing a substrate accommodated in each of the inertial sensors.

FIG. 10 is a block diagram showing the circuit configuration of a force detection circuit.

FIG. 11 is a longitudinal cross-sectional view showing variations of the force detection apparatus.

FIG. 12 is a block diagram showing one of the variations of the force detection apparatus.

FIG. 13 is a block diagram showing one of the variations of the force detection apparatus.

### DESCRIPTION OF EXEMPLARY EMBODIMENTS

A force detection apparatus and a robot system according to an embodiment of the present disclosure will be described below in detail with reference to the accompanying drawings.

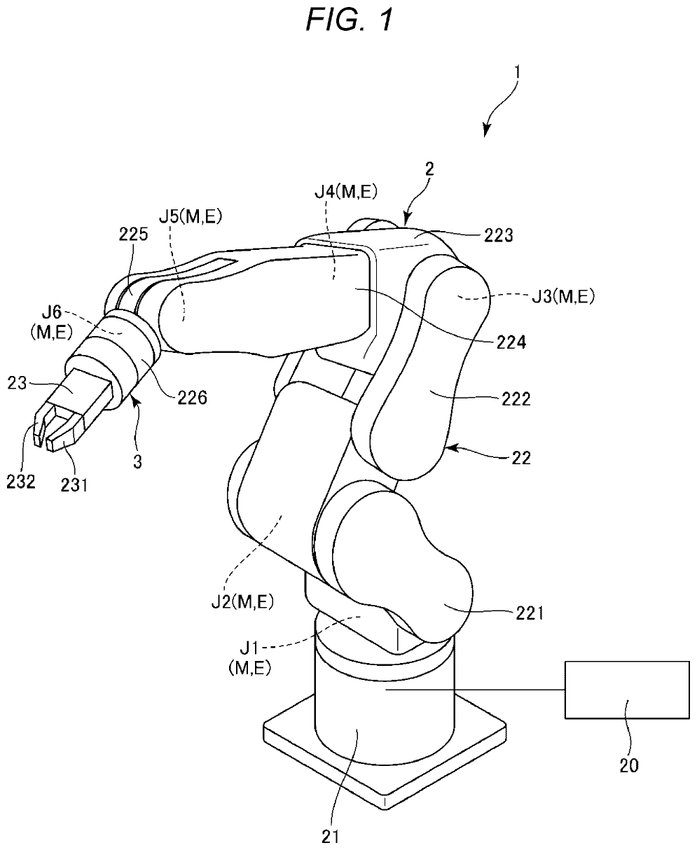

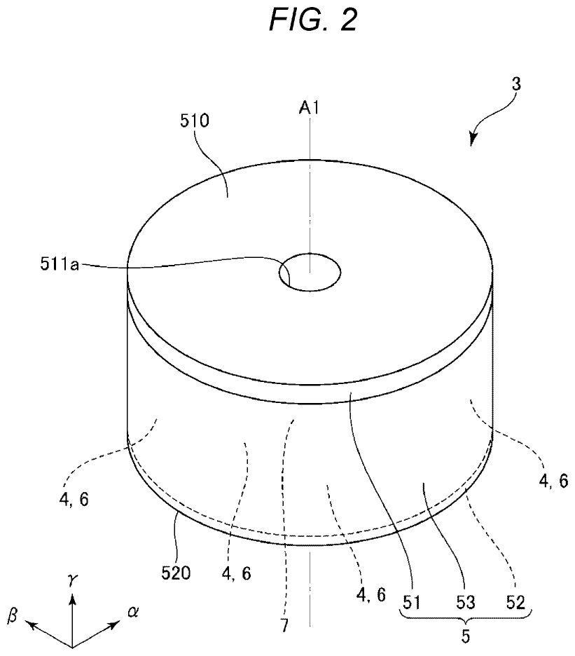

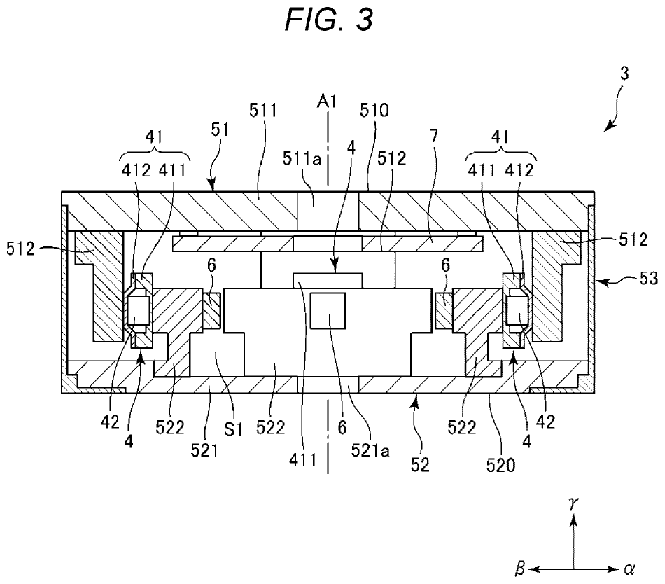

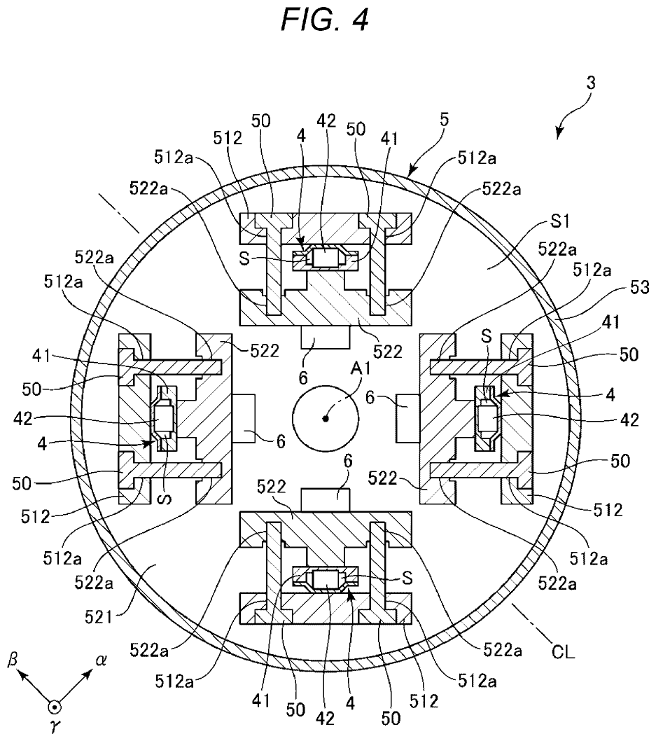

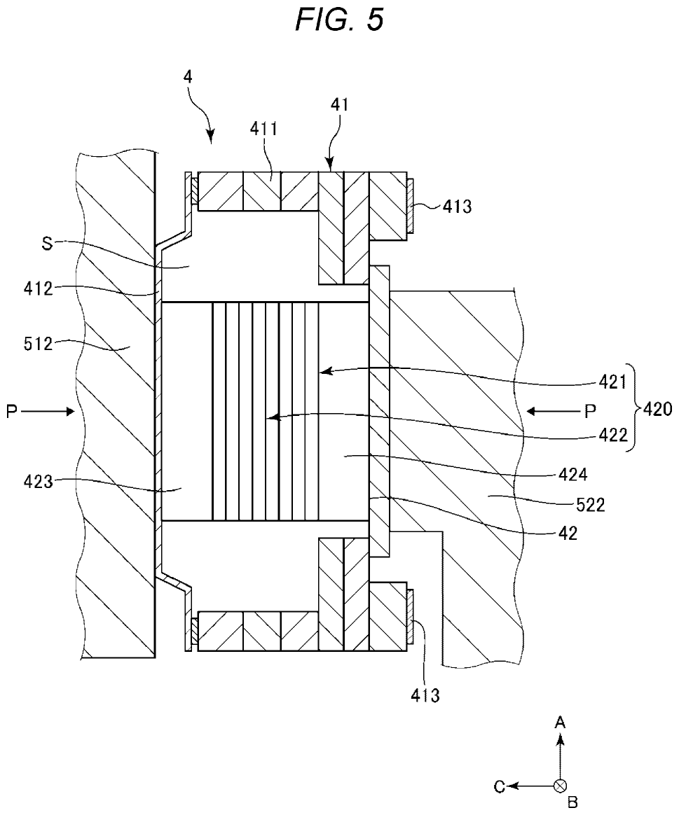

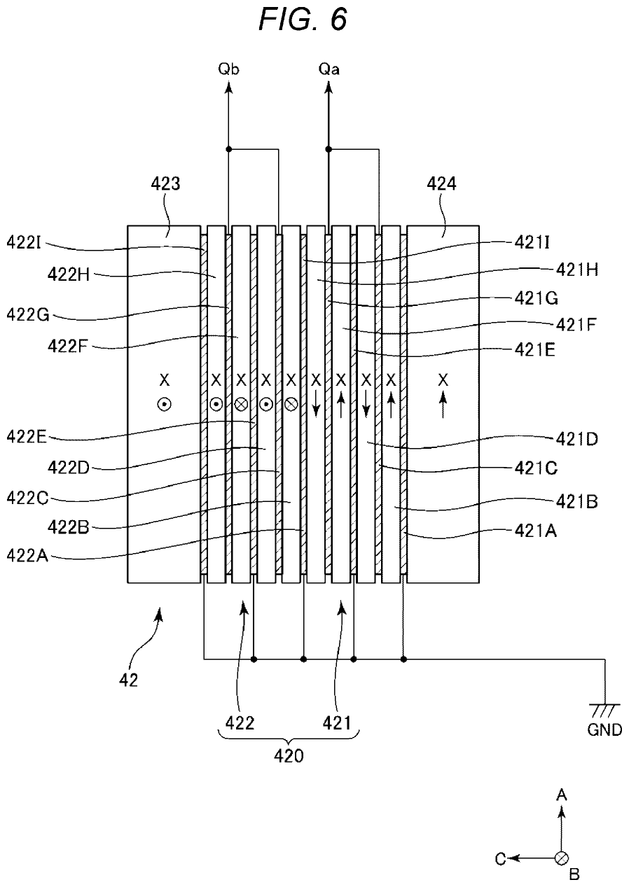

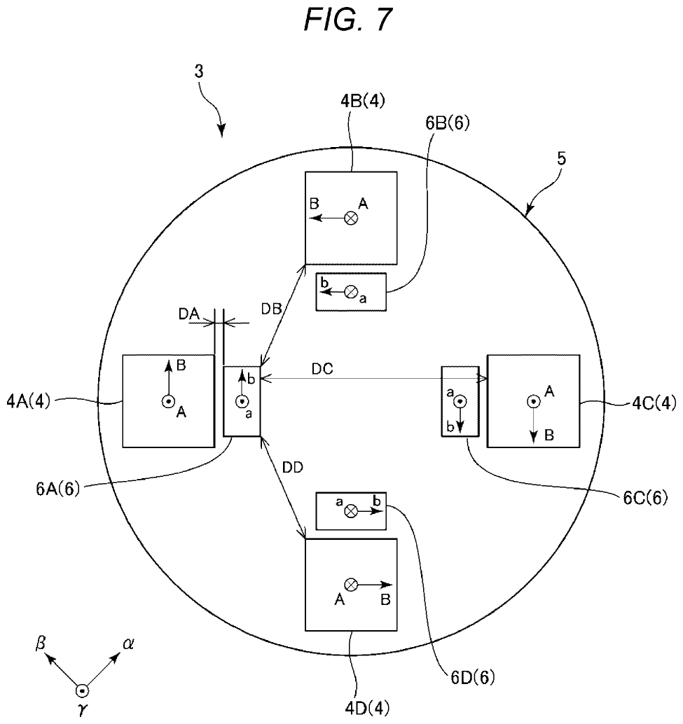

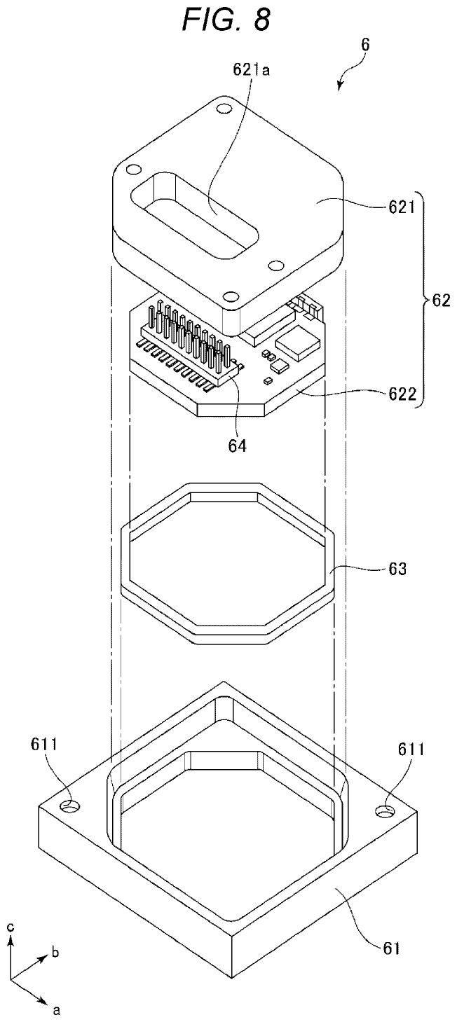

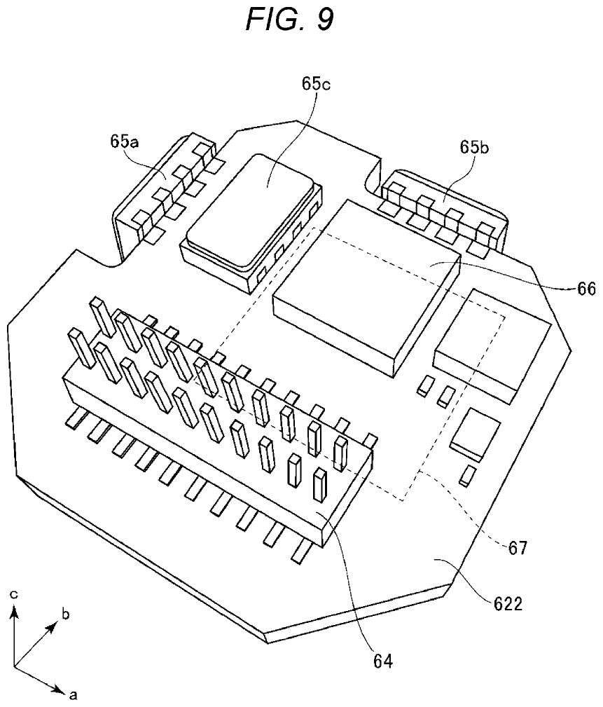

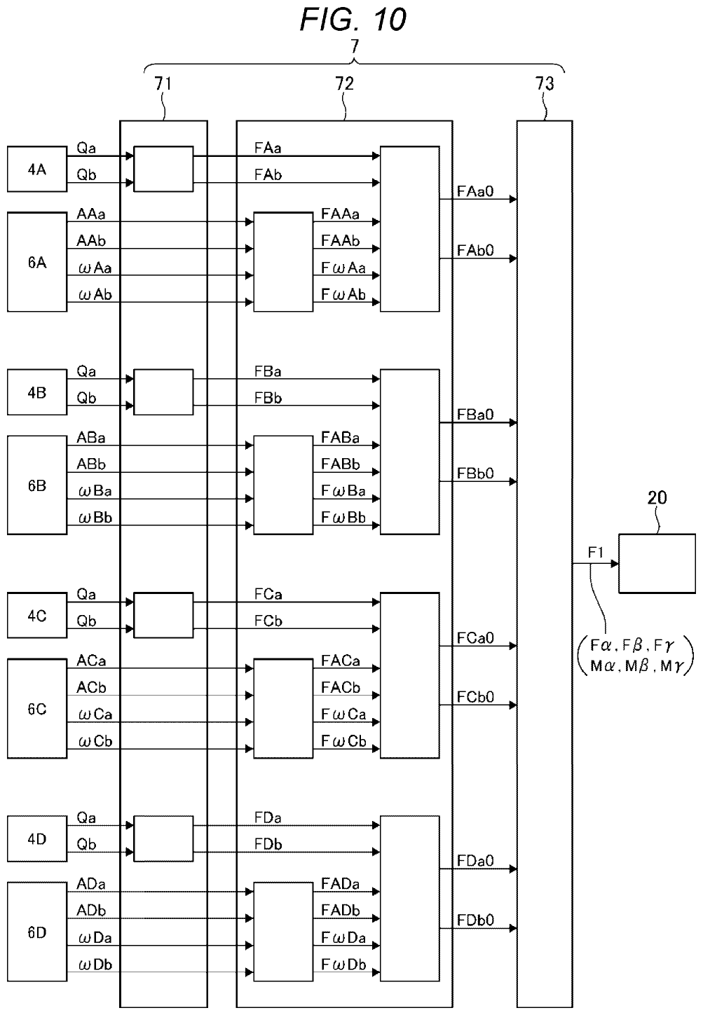

FIG. 1 is an overall configuration diagram of a robot system according to a preferable embodiment. FIG. 2 is a perspective view showing a force detection apparatus. FIG. 3 is a longitudinal cross-sectional view showing the force detection apparatus. FIG. 4 is a lateral cross-sectional view showing the force detection apparatus. FIG. 5 is a longitudinal cross-sectional view showing a force sensor. FIG. 6 is a longitudinal cross-sectional view showing a force detection device. FIG. 7 is a schematic diagram showing the arrangement of the force sensors and inertial sensors. FIG. 8 is an exploded perspective view showing each of the inertial sensors. FIG. 9 is a perspective view showing a substrate accommodated in each of the inertial sensors. FIG. 10 is a block diagram showing the circuit configuration of a force detection circuit.

### Robot System 1

A robot system 1 shown in FIG. 1 can, for example, supply, remove, transport, assemble, and otherwise handle target objects, such as a precision instrument and parts that form the precision instrument. The robot system 1 includes a robot 2, which is a single-armed six-axis vertically articulated robot, a robot control apparatus 20, which controls the operation of driving the robot 2, and a force detection apparatus 3 fitted to the robot 2.

The robot 2 includes a base 21, a robot arm 22 pivotably linked to the base 21, and an end effector 23. The base 21 is fixed, for example, to a floor, a wall, a ceiling, or the upper side of a movable cart. The robot arm 22 is a robotic arm formed of a plurality of arms 221, 222, 223, 224, 225, and 226 pivotably linked to each other and includes six joints J1 to J6. Out of the joints, the joints J2, J3, and J5 are bending joints, and the joints J1, J4, and J6 are torsional joints. It is, however, noted that the robot arm 22 is not limited to a specific robot arm, and that any robot arm can be selected as appropriate in accordance with a task to be performed.

The joints J1, J2, J3, J4, J5, and J6 are each provided with a motor M and an encoder E. The robot control apparatus 20 performs feedback control that causes the angles of rotation of the joints J1 to J6 indicated by the outputs of the respective encoders E to coincide with target angles of rotation that are control targets during the operation of the robot system 1. The angles of rotation of the joints J1 to J6 can thus be kept at the target values, whereby the robot arm 22 is allowed to have a desired position and posture. The robot 2 can therefore be driven in a desired motion.

The robot control apparatus 20 controls the operation of driving the robot 2. The robot control apparatus 20 is formed, for example, of a computer and includes a processor (CPU) that processes information, a memory communicably coupled to the processor, and an external interface via which the robot control apparatus 20 communicates with an external apparatus. The memory saves a variety of programs executable by the processor, and the processor can read and execute the variety of programs and other pieces of information stored in the memory. Part or entirety of the components of the robot control apparatus 20 may be disposed in an enclosure of the robot 2. The robot control apparatus 20 may instead be formed of a plurality of processors.

The end effector 23 is fitted to the front end of the robot arm 22, that is, the arm 226 via a mechanical interface. The end effector 23 is not limited to a specific component, and any component can be selected as appropriate in accordance with a task to be performed. The illustrated configuration includes a pair of jaws 231 and 232, which are opened and closed to grasp a workpiece that is not illustrated.

The force detection apparatus 3 is interposed between the robot arm 22 and the end effector 23. That is, the end effector 23 is fitted to the tip of the robot arm 22 via the force detection apparatus 3. The force detection apparatus 3 detects a force acting on the end effector 23 attached to the force detection apparatus 3. The force detection apparatus 3 will be described in detail below.

### Force Detection Apparatus 3

The force detection apparatus 3 is a six-axis force sensor capable of detecting six-axis components of an external force acting on the force detection apparatus 3. The six-axis components are formed of translational force (shear force) components in the directions of three axes perpendicular to each other, axes α, β, and γ, and rotational force (moment) components around the three axes.

The force detection apparatus 3 includes four force sensors 4 arranged at angular intervals of about 90° around a central axis A1 of the force detection apparatus 3, four inertial sensors 6 arranged in correspondence with the four force sensors 4, a force detection circuit 7, which detects the external force based on signals from the force sensors 4 and the inertial sensors 6, and an enclosure 5, which accommodates the components described above, as shown in FIG. 2. In the force detection apparatus 3, the output signals from each of the force sensors 4 are corrected based on the output signals from the corresponding inertial sensor 6, and the force detection apparatus 3 detects the external force acting thereon based on the four corrected signals.

The force detection apparatus 3 should detect only an external force F1 received when the end effector 23 comes into contact with a target object, but during the operation of the robot 2, the force sensing apparatus 3 receives, in addition to the external force F1, an external force F2 resulting from inertia, that is, angular velocity and acceleration generated by the driven robot arm 22. The signals from force sensors 4 alone cannot distinguish the external forces F1 and F2 from each other but can only detect a combined force F3, which is the combination of the external forces F1 and F2 (=F1+F2). The external force F1, which is the target to be detected, cannot therefore be accurately detected. To address the problem, the force detection apparatus 3 is provided with the inertial sensors 6, which detect the external force F2 acting on the force sensors 4, can detect the external force F1 by removing the external force F2 calculated based on the results of the detection performed by the inertial sensors 6 from the combined force F3 detected by the force sensors 4. The force detection apparatus 3, which detects the external force F1 by using the forces physically detected by the force sensors 4 and the forces physically detected by the inertial sensors 6, can thus detect the external force F1 with excellent accuracy.

The enclosure 5 includes a first enclosure member 51, a second enclosure member 52 disposed so as to be separate from the first enclosure member 51, and a side wall member 53 provided at the outer periphery of the first enclosure member 51 and the second enclosure member 52, as shown in FIG. 3. In the thus configured enclosure 5, an upper surface 510 of the first enclosure member 51 functions as an end effector attachment surface, to which the end effector 23 is attached, and a lower surface 520 of the second enclosure member 52 functions as an arm attachment surface, to which the robot arm 22 is attached. The upper surface 510 and the lower surface 520 may not necessarily function as described above, and the functions thereof may be reversed.

The first enclosure member 51 includes a top plate 511 and four pressure applicators 512 provided at the lower surface of the top plate 511 and arranged at equal intervals (angular intervals of 90°) around the center axis A1, as shown in FIGS. 3 and 4. The top plate 511 has a through hole 511a formed at the center of the plate and extending along the center axis A1. The pressure applicators 512 each have a plurality of through holes 512a, through which pressure applicating bolts 50, which will be described below, are inserted.

The second enclosure member 52 includes a bottom plate 521 and four pressure applicators 522 provided at the upper surface of the bottom plate 521 and arranged at equal intervals (angular intervals of 90°) around the center axis A1 so as to face the four pressure applicators 512 described above. The bottom plate 521 has a through hole 521a formed at the center of the plate and extending along the center axis A1. The pressure applicators 522 each have a plurality of female screw holes 522a, with which front end portions of the pressure applicating bolts 50 engage.

The side wall member 53 has a tubular shape, and upper and lower end portions of the side wall member 53 are fixed to the first enclosure member 51 and the second enclosure member 52, respectively, for example, by screwing or fitting. An internal space S1 surrounded by the side wall member 53 and the aforementioned top plate 511 and bottom plate 521 accommodates the four force sensors 4, the four inertial sensors 6, and the force detection circuit 7.

The four force sensors 4 are arranged so as to be symmetrical with respect to a line segment CL, which passes through the center axis A1 and is parallel to the axis 3 in the plan view, as shown in FIG. 4. The force sensors 4 are each located between the paired pressure applicators 512 and 522 and sandwiched therebetween. The pressure applicating bolts 50 link the pressure applicators 512 and 522 to each other to fix the first enclosure member 51 and the second enclosure member 52 to each other. Pressure is applied to the force sensors 4 located between the pressure applicators 512 and 522 when the pressure applicating bolts 50 are tightened. The force sensors 4 are each provided with a pair of pressure applicating bolts 50, which are located on opposite sides of the force sensor 4.

The force sensors 4 will next be described. The four force sensors 4 have the same configuration, so that one of the force sensors 4 will be described below as a representative, and the other three will not be described. For convenience of the following description, three axes perpendicular to one another, axes A, B, and C, are set in the force sensor 4. Furthermore, it is assumed that the tip side of the arrow indicating each of the axes is a “positive side”, and that the base side of the arrow is a “negative side”. The direction along the axis A is called an “axis-A direction,” the direction along the axis B is called an “axis-B direction,” and the direction along the axis C is called an “axis-C direction.

The force sensor 4 includes a package 41 and a force detection device 42 accommodated in the package 41, as shown in FIG. 5. The force sensor 4 is sandwiched between the pressure applicators 512 and 522, and the pressure applicating bolts 50 apply pressure to the force detection device 42 in the direction indicated by the arrows P. The external force acting on the force sensors 4, specifically, a shear force in the axis-A direction and a shear force in the axis-B direction are transmitted to the force detection device 42 via the package 41, and signals based on the received external force are outputted from the force detection device 42. Applying pressure to the force detection device 42 as described above allows accurate detection of the external force. The pressure applied to the force detection device 42 can be adjusted by adjusting the force that fastens the pressure bolts 50 as appropriate.

The package 41 includes a base 411 and a lid 412 joined to the base 411. An airtight accommodation space S is formed in the package 41, and the force detection device 42 is accommodated in the accommodation space S. The force detection device 42 can be protected from the outside environment, that is, can be dustproof and waterproof by accommodating the force detection device 42 in the package 41. The atmosphere in the accommodation space S is not particularly limited to a specific atmosphere but is preferably a vacuum state or a reduced-pressure state close to a vacuum.

The force detection device 42 outputs a charge Qa according to a component of the external force acting on the force detection device 42, the component in the axis-A direction, and a charge Qb according to a component of the external force, the component in the axis-B direction. The force detection device 42 includes a piezoelectric device 420 and a pair of intermediate substrates 423 and 424, which sandwich the piezoelectric device 420 in the axis-C direction. The piezoelectric device 420 includes a first piezoelectric device 421, which outputs the charge Qa in accordance with the shear force in the axis-A direction, and a second piezoelectric device 422, which outputs the charge Qb in accordance with the shear force in the axis-B direction.

The first piezoelectric device 421 has a configuration in which a ground electrode layer 421A, a piezoelectric layer 421B, an output electrode layer 421C, a piezoelectric layer 421D, a ground electrode layer 421E, a piezoelectric layer 421F, an output electrode layer 421G, a piezoelectric layer 421H, and a ground electrode layer 421I are sequentially stacked on each other from the negative side of the axis-C direction, as shown in FIG. 6. The second piezoelectric device 422 is stacked on the first piezoelectric device 421 and has a configuration in which a ground electrode layer 422A, a piezoelectric layer 422B, an output electrode layer 422C, a piezoelectric layer 422D, a ground electrode layer 422E, a piezoelectric layer 422F, an output electrode layer 422G, a piezoelectric layer 422H, and a ground electrode layer 422I are sequentially stacked on each other from the negative side of the axis-C direction. In the present embodiment, the ground electrode layers 421I and 422A are integrated with each other.

The piezoelectric layers 421B, 421D, 421F, 421H, 422B, 422D, 422F, and 422H are each formed of a Y-cut quartz plate, that is, a quartz plate having a thickness direction extending along the axis Y (mechanical axis), which is the crystal axis of quartz. The force detection device 42 can thus have excellent characteristics, such as high sensitivity, a wide dynamic range, and high rigidity. In the piezoelectric layers 421B and 421F, the axis X (electric axis), which is the crystal axis of the quartz, is oriented toward the positive side of the axis-A direction, whereas in the piezoelectric layers 421D and 421H, the axis X of the quartz is oriented toward the negative side of the axis-A direction. In the piezoelectric layers 422B and 422F, the axis X of the quartz is oriented toward the positive side of the axis-B direction, whereas in the piezoelectric layers 422D and 422H, the axis X of the quartz is oriented toward the negative side of the axis-B direction.

It is, however, noted that the piezoelectric layers 421B, 421D, 421F, 421H, 422B, 422D, 422F, and 422H may be made of a piezoelectric material other than quartz. Examples of the piezoelectric material other than quartz may include topaz, barium titanate, lead titanate, lead zirconate titanate (PZT: Pb(Zr,Ti)O₃), lithium niobate, and lithium tantalate.

The ground electrode layers 421A, 421E, 421I, 422A, 422E, and 422I are electrically coupled to ground potential GND. The charge Qa according to the component in the axis-A direction is outputted from the output electrode layers 421C and 421G, and the charge Qb according to the component in the axis-B direction is outputted from the output electrode layers 422C and 422G. The charges Qa and Qb are sent to the force detection circuit 7 via terminals 413 provided at the base 411.

The pair of intermediate substrates 423 and 424 are disposed so as to sandwich the piezoelectric device 420 from opposite sides in the axis-C direction. The intermediate substrates 423 and 424 can thus cover the ground electrode layers 421A and 422I and can therefore protect the ground electrode layers 421A and 422I and suppress unintended conduction between the ground electrode layers 421A, 422I and the package 41. Furthermore, the intermediate substrates 423 and 424 can uniformly transmit the pressure applied in the axis-C direction to the entire area of the piezoelectric device 420.

The intermediate substrates 423 and 424 are made of quartz. The intermediate substrates 423 and 424 thus have high mechanical strength and can properly transmit the external force to the force detection device 42. Furthermore, the intermediate substrate 423 has the same configuration as that of the adjacent piezoelectric layer 422H. That is, the intermediate substrate 423 is a Y-cut quartz plate with the axis X of the quartz oriented toward the negative side of the axis-B direction. Similarly, the intermediate substrate 424 has the same configuration as that of the adjacent piezoelectric layer 421B. That is, the intermediate substrate 424 is a Y-cut quartz plate with the axis X of the quartz oriented toward the positive side of the axis-A direction. The configuration described above in which the crystal axes of the intermediate substrates 423 and 424 coincide with the crystal axes of the adjacent piezoelectric layers 422H and 421B allows the intermediate substrates 423 and 424 and the piezoelectric layers 422H and 421B to have the same coefficient of thermal expansion, whereby an output drift caused by thermal expansion can be effectively reduced.

The force sensors 4 have been described above. Let now the four force sensors 4 be called force sensors 4A, 4B, 4C, and 4D, and the orientations of the four force sensors 4A, 4B, 4C, and 4D are as shown in FIG. 7. The force sensor 4A has an axis A oriented toward the positive side of the axis γ and an axis B inclining by +45° with respect to the axis β. The force sensor 4B has an axis A oriented toward the negative side of the axis γ and an axis B inclining by −45° with respect to the axis β. The force sensor 4C has an axis A oriented toward the positive side of the axis γ and an axis B inclining by −135° with respect to the axis β. The force sensor 4D has an axis A oriented toward the negative side of the axis γ and an axis B inclining by +135° with respect to the axis β.

In the arrangement described above, the axes B that are the force detection axes of the force sensors 4A and 4C and the axes B that are the force detection axes of the force sensors 4B and 4D intersect with each other in the plan view viewed in the axis γ. The configuration described above in which the force detection axes of the plurality of force sensors 4 do not coincide with one another but intersect with one another allows detection of the six-axis components of the external force. In the present embodiment, in particular, the axes B of the force sensors 4A and 4C and the axes B of the force sensors 4B and 4D are perpendicular to each other, whereby the six-axis components of the external force can be more accurately detected. In the present embodiment, the force sensors 4A and 4C are each a “first force sensor”, and the force sensors 4B and 4D are each a “second force sensor”.

The inertial sensors 6 will next be described. The four inertial sensors 6 have the same configuration, and one of the inertial sensors 6 will therefore be described below as a representative. For convenience of the following description, three axes perpendicular to one another, axes a, b, and c, are set as inertia detection axes of the inertial sensor 6. Furthermore, it is assumed that the tip side of the arrow indicating each of the axes is a “positive side”, and that the base side of the arrow is a “negative side”. Moreover, the direction along the axis a is called an “axis-a direction,” the direction along the axis b is called an “axis-b direction,” and the direction along the axis c is called an “axis-c direction.

The inertial sensor 6 is also called an inertial measurement unit (IMU) and is a six-axis sensor capable of detecting angular velocity around each of the axes a, b, and c and acceleration in the direction of each of the axes independently from one another. The inertial sensor 6 includes an outer enclosure 61, a sensor module 62 inserted into the outer enclosure 61, and a joining member 63, which joins the outer enclosure 61 to the sensor module 62, as shown in FIG. 8. The outer enclosure 61 has a box-like outer shape having a substantially square planar shape and has two screw holes 611 for attachment formed in the vicinity of two vertices on a diagonal of the square shape.

The sensor module 62 includes an inner enclosure 621 and a substrate 622. The inner enclosure 621 is a member that supports the substrate 622 and is shaped so as to fit into the outer enclosure 61. The inner enclosure 621 has an opening 621a formed therein, and a connector 64, which will be described later, is exposed through the opening 621a. The thus configured inner enclosure 621 is joined to the outer enclosure 61 via the joining member 63.

The following components are mounted on the upper surface of the substrate 622 as shown in FIG. 9: the connector 64; an angular velocity sensor 65c, which detects angular velocity around the axis c; an acceleration sensor 66, which detects acceleration in the directions of each of the axes a, b, and c; and other components. Furthermore, the following components are mounted on the side surface of the substrate 622: an angular velocity sensor 65a, which detects angular velocity around the axis a; and an angular velocity sensor 65b, which detects angular velocity around the axis b.

A control IC 67 is mounted on the lower surface of the substrate 622. The control IC 67 is a micro-controller unit (MCU) and controls each portion of the inertial sensor 6. The control IC 67 includes a processor (CPU) that processes information, a memory that is communicatively coupled to the processor, and an external interface. The memory saves a program executable by the processor, and the processor reads the program stored in the memory and executes the program. The thus configured control IC 67 detects the angular velocity around each of the axes a, b, and c and the acceleration in the direction of each of the axes independently from one another based on output signals from the angular velocity sensors 65a, 65b, and 65c and the acceleration sensor 66.

The inertial sensors 6 have been described above. Let now the four inertial sensors 6 be called inertial sensors 6A, 6B, 6C, and 6D, and the arrangement of the four inertial sensors 6A, 6B, 6C, and 6D is as shown in FIG. 7.

The inertial sensor 6A is paired with the force sensor 4A, fixed to the same pressure applicator 522 as that to which the force sensor 4A is fixed, and disposed in the vicinity of the force sensor 4A. The inertial sensor 6B is paired with the force sensor 4B, fixed to the same pressure applicator 522 as that to which the force sensor 4B is fixed, and disposed in the vicinity of the force sensor 4B. The inertial sensor 6C is paired with the force sensor 4C, fixed to the same pressure applicator 522 as that to which the force sensor 4C is fixed, and disposed in the vicinity of the force sensor 4C. The inertial sensor 6D corresponds to the force sensor 4D, is fixed to the same pressure applicator 522 as that to which the force sensor 4D is fixed, and is disposed in the vicinity of the force sensor 4D. The configuration described above in which the paired sensors are disposed in close proximity to each other allows the inertial sensors 6 to each accurately detect the acceleration and angular velocity acting along each of the detection axes of the paired force sensor 4. In the present embodiment, the inertial sensors 6A and 6C paired with the force sensors 4A and 4C are each a “first inertial sensor”, and the inertial sensors 6B and 6D paired with the force sensors 4B and 4D are each a “second inertial sensor”.

The arrangement in which the inertial sensor 6A is disposed in the vicinity of the force sensor 4A means that a separation distance DA between inertial sensor 6A and the force sensor 4A is smaller than a separation distance DB between the inertial sensor 6A and the force sensor 4B, which is not paired therewith, a separation distance DC between the inertial sensor 6A and the force sensor 4C, which is not paired therewith, and a separation distance DD between the inertial sensor 6A and the force sensor 4D, which is not paired therewith, as shown in FIG. 7. The same holds true for the inertial sensors 6B, 6C, and 6D. The inertial sensors 6 can thus accurately detect the acceleration and angular velocity acting on the paired force sensors 4.

The orientations of the inertial sensors 6A, 6B, 6C, and 6D are as shown in FIG. 7. The axes a and b of the inertial sensor 6A extend along the axes A and B of the paired force sensor 4A, respectively. The axes a and b of the inertial sensor 6B extend along the axes A and B of the paired force sensor 4B, respectively. The axes a and b of the inertial sensor 6C extend along the axes A and B of the paired force sensor 4C, respectively. The axes a and b of the inertial sensor 6D extend along the axes A and B of the paired force sensor 4D, respectively.

The configuration described above in which the inertial detection axis of each of the inertial sensors 6 and the force detection axis of the paired force sensor 4 are aligned with each other allows the inertial sensor 6 to accurately detect the acceleration component and the angular velocity component contained in the signals outputted from the paired force sensor 4 (charges Qa and Qb). The meaning of the aforementioned sentence “the axis a extends along the axis A” includes not only the case where the axis a and the axis A are parallel to each other or located on the same straight line but, for example, a case where there is a technically acceptable error or an error that can occur in the manufacture. The same holds true for the aforementioned sentence “the axis b extends along the axis B”, and the meaning of the sentence includes not only the case where the axis b and the axis B are parallel to each other or located on the same straight line but, for example, the case where there is a technically acceptable error or an error that can occur in the manufacture.

In the description, the inertial sensors 6 are each a six-axis sensor capable of independently detecting the angular velocity around each of the axes a, b, and c and the acceleration in the direction of each of the axes, but the force detection apparatus 3 does not use the acceleration in the direction of the axis c or the angular velocity around the axis c. The device that detects the acceleration in the direction of the axis c and the angular velocity around the axis c may be omitted from each of the inertial sensors 6. That is, the inertial sensors 6 each only need be capable of detecting the angular velocity around each of the axes a and b and the acceleration in the direction of each of the axes a and b.

The force detection circuit 7 will next be described. The force detection circuit 7 detects the external force F1 that the end effector 23 receives based on the signals from the force sensors 4 and the inertial sensors 6. The force detection circuit 7 includes a first processing section 71, which calculates a force based on the signals from the force sensors 4, a second processing section 72, which removes the inertial components from the force calculated by the first processing section 71, and a third processing section 73, which calculates the external force F1 based on the force calculated by the second processing section 72, as shown in FIG. 10.

The first processing unit 71 calculates the force acting on the force sensor 4A (shear force FAa in direction of axis A and shear force FAb in direction of axis B) based on the charges Qa and Qb from the force sensor 4A, calculates the force acting on the force sensor 4B (shear force FBa in direction of axis A and shear force FBb in direction of axis B) based on the charges Qa and Qb from the force sensor 4B, calculates the force acting on the force sensor 4C (shear force FCa in direction of axis A and shear force FCb in direction of axis B) based on the charges Qa and Qb from the force sensor 4C, and calculates the force acting on the force sensor 4D (shear force FDa in direction of axis A and shear force FDb in direction of axis B) based on the charges Qa and Qb from the force sensor 4D.

The detected shear forces FAa to FDa in the direction of the axis A that are calculated by the first processing section 71 include the acceleration components in the direction of the axis A and the angular velocity components around the axis A, which act on the end effector 23 resulting from the driven robot arm 22, and the shear forces FAb to FDb in the direction of the axis B that are calculated by the first processing section 71 include the acceleration components in the direction of the axis B and the angular velocity components around the axis B, which act on the end effector 23 resulting from the driven robot arm 22, as described above. The second processing section 72 then removes the acceleration components in the direction of the axis A and the angular velocity components around the axis A from the shear forces FAa to FDa in the direction of the axis A that have been calculated by the first processing section 71 and removes the acceleration components in the direction of the axis B and the angular velocity components around the axis B from the shear forces FAb to FDb in the direction of the axis B that have been calculated by the first processing section 71.

The second processing section 72 calculates a shear force FAAa, which results from the acceleration in the direction of the axis A and is received by the force sensor 4A, based on acceleration AAa in the direction of the axis a detected by the inertial sensor 6A, calculates a shear force FAAb, which results from the acceleration in the direction of the axis B and is received by the force sensor 4A, based on acceleration AAb in the direction of the axis b detected by the inertial sensor 6A, calculates a shear force FωAa, which results from the angular velocity around the axis A and is received by the force sensor 4A, based on angular velocity ωAa around the axis a detected by the inertial sensor 6A, and calculates a shear force FωAb, which results from the angular velocity around the axis B and is received by the force sensor 4A, based on angular velocity ωAb around the axis b detected by the inertial sensor 6A.

Since the inertial sensor 6A is disposed in the vicinity of the force sensor 4A paired therewith as described above, the inertia received by the inertial sensor 6A can be substantially equal to the inertia received by the force sensor 4A. The shear forces FAAa, FAAb, FωAa, and FωAb can therefore be accurately detected.

The shear forces FAAa and FAAb can be calculated, for example, by multiplication of the acceleration AAa and AAb by a coefficient calculated from the mass of the end effector 23 and other factors. The shear forces FωAa and FωAb can be calculated, for example, by multiplication of the angular velocity ωAa and ωAb by the coefficient calculated from the mass of the end effector 23 and other factors. It is, however, noted that how to calculate the shear forces FAAa, FAAb, FωAa, and FωAb is not limited to a specific method.

Similarly, the second processing section 72 determines shear forces FABa, FABb, FACa, FACb, FADa, and FADb, which result from the acceleration in the directions of the axes A and B and are received by the force sensors 4B, 4C, and 4D, based on acceleration Aba, ABb, ACa, ACb, ADa, and ADb in the directions of the axes a and b detected by the inertial sensors 6B, 6C, and 6D and determines shear forces FωBa, FωBb, FωCa, FωCb, FωDa, and FωDb, which result from the angular velocity around the axes A and B and are received by the force sensors 4B, 4C, and 4D, based on angular velocity ωba, ωBb, ωCa, ωCb, ωDa, and ωDb around the axes a and b detected by the inertial sensors 6B, 6C, and 6D.

The second processing section 72 then subtracts the shear forces FAAa and FωAa from the shear force FAa to calculate a corrected shear force FAa0 and subtracts the shear forces FAAb and FωAb from the shear force FAb to calculate a corrected shear force FAb0. That is, FAa0=FAa−(FAAa+FωAa), and FAb0=FAb−(FAAb+FωAb). The corrected shear forces FAa0 and FAb0, which are the results of the removal of the force components resulting from the acceleration and the angular velocity received by the force sensor 4A from the shear forces FAa and FAb, can thus be produced.

Similarly, the second processing section 72 subtracts the shear forces FABa and FωBa from the shear force FBa to calculate a corrected shear force FBa0 and subtracts the shear forces FABb and FωBb from the shear force FBb to calculate a corrected shear force FBb0. The second processing section 72 further subtracts the shear forces FACa and FωCa from the shear force FCa to calculate a corrected shear force FCa0 and subtracts the shear forces FACb and FωCb from the shear force FCb to calculate a corrected shear force FCb0. The second processing section 72 further subtracts the shear forces FADa and FωDa from the shear force FDa to calculate a corrected shear force FDa0 and subtracts the shear forces FADb and FωDb from the shear force FDb to calculate a corrected shear force FDb0.

The third processing section 73 calculates the external force F1 (translational force component Fa in axis-α direction, translational force component Fβ in axis-β direction, translational force component Fγ in axis-γ direction, rotational force component Ma around axis α, rotational force component Mβ around axis β, and rotational force component My around axis γ) received by the end effector 23 based on the eight corrected shear forces FAa0, FAb0, FBa0, FBb0, FCa0, FCb0, FDa0, and FDb0 calculated by the second processing section 72. The thus calculated external force F1 is transmitted to the robot control apparatus 20. The robot control apparatus 20 controls the operation of driving the robot 2 based on the external force F1. The robot 2 can thus be controlled with greater accuracy.

The robot system 1 and the force detection apparatus 3 have been described. The force detection apparatus 3 includes the force sensor 4A, which serves as the first force sensor and includes the force detection device 42 having a force detection axis, and the force sensor 4B, which serves as the second force sensor and includes the force detection device 42 having a force detection axis, the inertial sensor 6A, which serves as the first inertial sensor, is disposed in the vicinity of the force sensor 4A, and has an inertia detection axis extending along the force detection axis of the force sensor 4A, and the inertial sensor 6B, which serves as the second inertial sensor, is disposed in the vicinity of the force sensor 4B, and has an inertia detection axis extending along the force detection axis of the force sensor 4B, as described above. The configuration described above allows detection of the external force based on the forces physically detected by the force sensors 4A and 4B and the inertia physically detected by the inertial sensors 6A and 6B. The external force can therefore be detected with excellent accuracy.

The separation distance DA between the inertial sensor 6A and the force sensor 4A is smaller than the separation distance DB between the inertial sensor 6A and the force sensor 4B, and the separation distance between the inertial sensor 6B and the force sensor 4B is smaller than the separation distance between the inertial sensor 6B and the force sensor 4A, as described above. The inertial sensor 6A and the force sensor 4A are thus disposed closer to each other, whereby the accuracy of the external force detection is further increased.

The inertial sensors 6A and 6B are sensors that detect acceleration in the directions along axes a and b as the inertia detection axes, sensors that detect angular velocity around the axes a and b, or sensors that detect both acceleration in the directions along axes a and b and angular velocity around the axes a and b, as described above. The forces resulting from the inertia acting on the force sensors 4A and 4B can thus be accurately detected. In particular, the inertial sensors 6A and 6B in the present embodiment are sensors that detect both acceleration in the directions along the axes a and b and angular velocity around the axes a and b. The effects described above are therefore even more remarkable.

The force sensors 4A and 4B have force detection axes that intersect with each other, as described above. In the present embodiment, the axes B of the force sensors 4A and 4B intersect with each other. The force detection apparatus 3 can thus detect force components in a greater number of directions, whereby the accuracy of the force detection performed by the force detection apparatus 3 is improved.

The force detection devices 42 each include the piezoelectric layers 421B, 421D, 421F, 421H, 422B, 422D, 422F, and 422H, which are each a quartz plate, as described above. The force detection devices 42 can each thus have excellent characteristics, such as high sensitivity, a wide dynamic range, and high rigidity.

The force detection apparatus 3 includes the force detection circuit 7, which calculates the corrected shear forces FAa0 and FAb0, which are each a first force resulting from the removal of the inertia components from the shear forces FAa and FAb as the forces received by the force sensor 4A, based on the results of the detection performed by the inertial sensor 6A, calculates the corrected shear forces FBa0 and FBb0, which are each a second force resulting from the removal of the inertia components from the shear forces FBa and FBb as the forces received by the force sensor 4B, based on the results of the detection performed by the inertial sensor 6B, and calculates the received external force F1 based on the corrected shear forces FAa0 and FAb0 and the corrected shear forces FBa0 and FBb0, as described above. The external force can thus be accurately detected.

The robot system 1 includes the robot 2, the force detection apparatus 3 incorporated in the robot 2, and the robot control apparatus 20, which controls the operation of driving the robot 2 based on the results of the detection performed by the force detection apparatus 3, as described above. The force detection apparatus 3 includes the force sensor 4A, which serves as the first force sensor and includes the force detection device 42 having a force detection axis, and the force sensor 4B, which serves as the second force sensor and includes the force detection device 42 having a force detection axis, the inertial sensor 6A, which serves as the first inertial sensor, is disposed in the vicinity of the force sensor 4A, and has an inertia detection axis extending along the force detection axis of the force sensor 4A, and the inertial sensor 6B, which serves as the second inertial sensor, is disposed in the vicinity of the force sensor 4B, and has an inertia detection axis extending along the force detection axis of the force sensor 4B. The configuration described above allows detection of the external force based on the forces physically detected by the force sensors 4A and 4B and the inertia physically detected by the inertial sensors 6A and 6B. The external force can therefore be detected with excellent accuracy.

The force detection apparatus and the robot system according to the present disclosure have been described above based on the illustrated embodiment, but the present disclosure is not limited thereto, and the configuration of each portion can be replaced with any configuration having the same function. Further, any other constituent element may be added to any of the embodiment of the present disclosure. The force detection apparatus according to the embodiment of the present disclosure can also be incorporated in an instrument other than robot systems. For example, the force detection apparatus according to the embodiment of the present disclosure may be incorporated in a vehicle, such as an automobile.

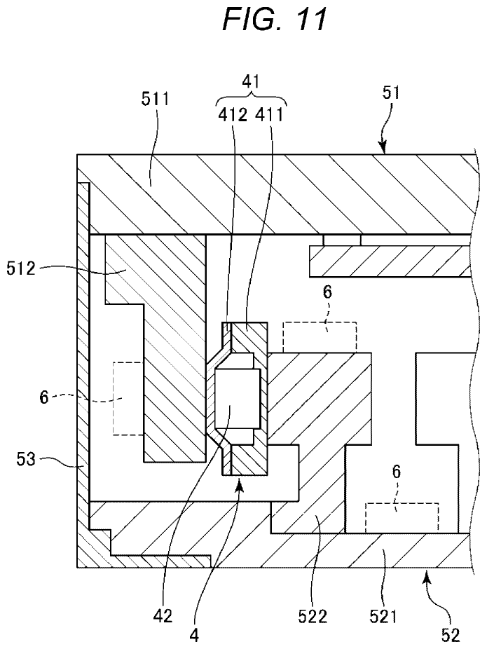

For example, in the embodiment described above, the inertial sensors 6 are disposed at the side surfaces of the pressure applicators 522 so as to face the force sensors 4A, but not necessarily as long as the inertial sensors 6 are disposed in the vicinity of the paired force sensors 4. For example, the inertial sensors 6 may be disposed at the upper surfaces of the pressure applicators 522, at the bottom plate 521 of the second enclosure member 52, or at the side surfaces of the pressure applicators 512 so as to face the force sensors 4, as shown in FIG. 11.

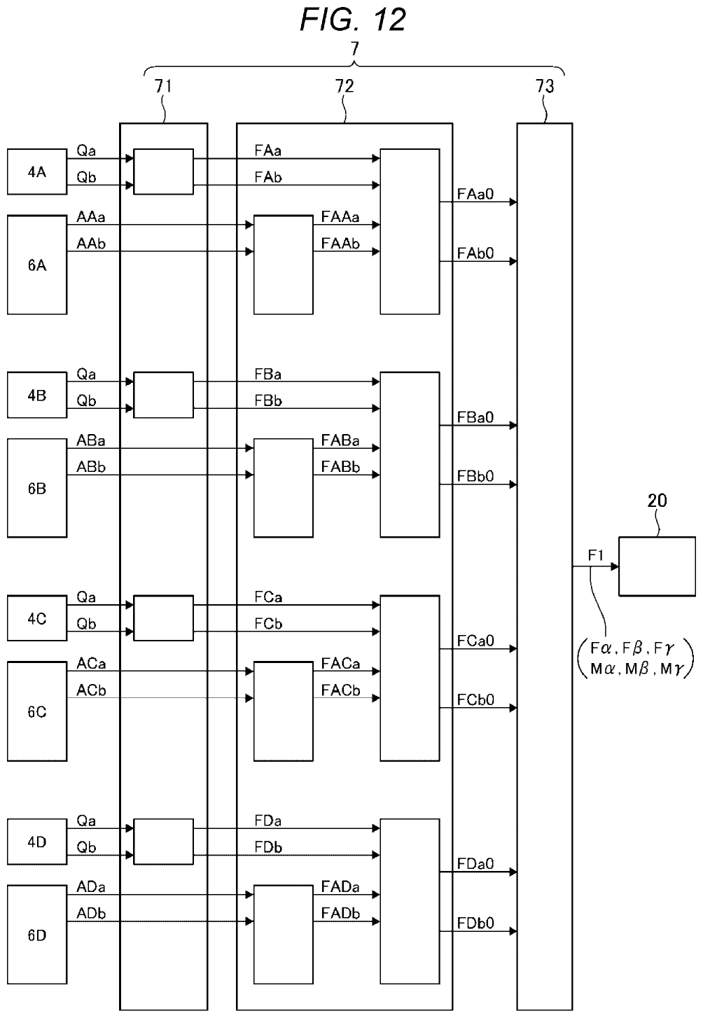

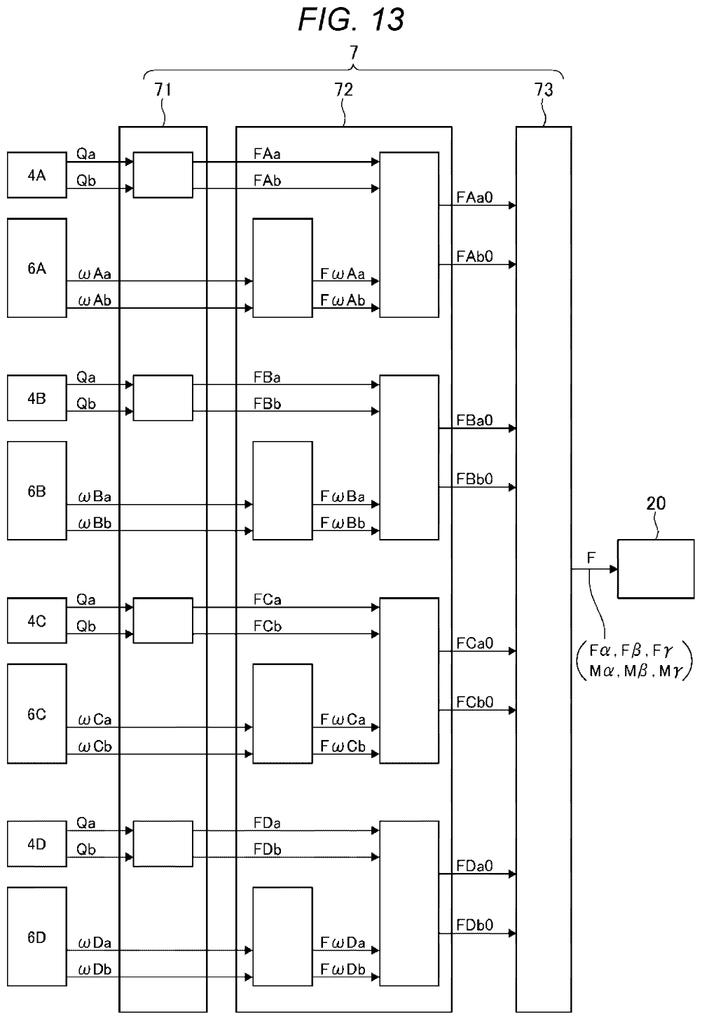

For example, in the embodiment described above, the inertial sensors 6 each detect both acceleration and angular velocity, but not necessarily, and may detect either acceleration or angular velocity. That is, the configuration shown in FIG. 12 or 13 may be employed. In FIG. 12, the shear forces are calculated as follows: FAa0=FAa−FAAa and FAb0=FAa−FAAb, and in FIG. 13, the shear forces are calculated as follows: FAa0=FAa−FωAa and FAb0=FAb−FωAb. The same holds true for FBa0, FBb0, FCa0, FCb0, FDa0, and FDb0. The configuration described above can also provide the same effects as those provided by the embodiment described above.

What is claimed is:

1. A force detection apparatus comprising:
first and second force sensors each including a force detection device having a force detection axis;
a first inertial sensor disposed in a vicinity of the first force sensor and having an inertia detection axis extending along the force detection axis of the first force sensor; and
a second inertial sensor disposed in a vicinity of the second force sensor and having an inertia detection axis extending along the force detection axis of the second force sensor.

2. The force detection apparatus according to claim 1,
wherein a separation distance between the first inertial sensor and the first force sensor is smaller than a separation distance between the first inertial sensor and the second force sensor, and
a separation distance between the second inertial sensor and the second force sensor is smaller than a separation distance between the second inertial sensor and the first force sensor.

3. The force detection apparatus according to claim 1, wherein the first and second inertial sensors are each a sensor that detects acceleration in a directions along the inertial detection axis, a sensor that detects angular velocity around the inertial detection axis, or a sensor that detects both the acceleration and the angular velocity.

4. The force detection apparatus according to claim 1, wherein the force detection axes of the first and second force sensors intersect with each other.

5. The force detection apparatus according to claim 1, wherein the force detection devices each include a quartz plate.

6. The force detection apparatus according to claim 1, further comprising a force detection circuit that calculates a first force resulting from removal of an inertia component from a force received by the first force sensor based on a result of detection performed by the first inertial sensor, calculates a second force resulting from removal of an inertia component from a force received by the second force sensor based on a result of detection performed by the second inertial sensor, and calculates a received external force based on the first force and the second force.

7. A robot system comprising:
a robot;
a force detection apparatus incorporated in the robot; and
a robot control apparatus that controls the operation of driving the robot based on a result of detection performed by the force detection apparatus,
wherein the force detection apparatus includes
first and second force sensors each including a force detection device having a force detection axis,
a first inertial sensor disposed in a vicinity of the first force sensor and having an inertia detection axis extending along the force detection axis of the first force sensor, and
a second inertial sensor disposed in a vicinity of the second force sensor and having an inertia detection axis extending along the force detection axis of the second force sensor.
